(19) United States
(12) Patent Application Publication
(10) Pub. No.: US 2011/0098332 A1
(43) Pub. Date: Apr. 28, 2011

(54) Insecticides for Increasing the Crop Yield

(75) Inventors: Dirk Voeste, Limburgerhof (DE); Lutz Brahm, Worms (DE)

(73) Assignee: BASF SE, Ludwigshafen (DE)

(21) Appl. No.: 12/673,513

(22) PCT Filed: Aug. 15, 2008
(86) PCT No.: PCT/EP08/60765

§ 371 Date: Feb. 15, 2010

(30) Foreign Application Priority Data
Aug. 17, 2007 (EP) 07114555.1

(51) Int. Cl. A01N 43/56; A01P 7/04

(52) U.S. Cl. 514/407

(57) ABSTRACT

The present invention relates to the use of at least one insecticide selected from GABA antagonists for increasing the crop yield of at least one plant variety and to a method for increasing the crop yield of at least one plant variety by treating the propagules from which it is to grow with at least one GABA antagonist insecticide.

The present invention relates to the use of at least one insecticide selected from GABA antagonists for increasing the crop yield of at least one plant variety and to a method for increasing the crop yield of at least one plant variety by treating the propagules from which it is to grow with at least one GABA antagonist insecticide.

Apart from the control of animal and fungal plagues, farmers' main concern has ever been the optimization of crop yield. Justus von Liebig's findings on plant nutrition and the artificial fertilizers developed thereupon have relieved an important part of these concerns. Artificial fertilizers are generally composed of macronutrients, which are nitrogen, phosphorus and potassium compounds (NPK-fertilizers). Calcium, magnesium and sulphur, which are also macronutrients, may also be part of artificial fertilizers, but are often supplied to the plant via manure or liming. Artificial fertilizers may further comprise micronutrients, i.e. nutrients which are consumed by the plants in distinctly smaller quantities then macronutrients, such as iron, manganese, boron, copper, molybdenum, nickel, chlorine, and zinc.

In the last decades, however, over-fertilization and inadequate application of artificial fertilizers has created new problems. Thus, the massive quantities of chemical fertilizers applied have been found to have a negative impact on soil nutrient holding structures. The high solubilities of chemical fertilizers also exacerbate their tendency to de-grade ecosystems. Storage and application of some nitrogen fertilizers in some weather or soil conditions can cause emissions of the greenhouse gas nitrous oxide (N₂O). Ammonia gas (NH₃) may be emitted following application of inorganic fertilizers, or manure or slurry. Besides supplying nitrogen, ammonia can also increase soil acidity (“souring”). Excessive nitrogen fertilizer applications can also lead to pest problems by increasing the birth rate, longevity and overall fitness of certain pests. Accordingly, under certain environmental conditions it might be desirable or unavoidable to grow crop plants in a soil having a suboptimal nitrogen content (suboptimal referring here to a quantity of nitrogen compounds which is lower than the quantity required for a maxi-mum crop yield).

Of course it is at the same time desirable to avoid too big yield losses due to a suboptimal nutrient content of the soil.

It is an object of the present invention to provide compounds which increase the crop yield of plants. In particular, the object of the invention is to provide compounds which increase the crop yield of plants growing in a medium with a suboptimal nitrogen content and which thus counteract the deficient nutrient content.

Surprisingly it was found that a special class of insecticides has this countervailing effect.

Accordingly, the object of the invention is achieved by the use of at least one insecticide selected from GABA antagonists for increasing the crop yield of at least one plant variety.

Another aspect of the invention relates to a method for increasing the crop yield of at least one plant variety, which method comprises treating the plant propagules from which the plant is to grow with at least one insecticide selected from GABA antagonists.

The term “crop” refers to all plant products which are of economical value. Examples are fruits, seeds, grains, oil, wood, fibers and the like. Preferably the term refers to fruits, seeds and grains. For example, in case of cereals, crop refers to the cereal grains.

“Propagules” are all types of plant propagation material. The term embraces seeds, grains, fruit, tubers, rhizomes, spores, cuttings, offshoots, meristem tissues, single and multiple plant cells and any other plant tissue from which a complete plant can be obtained. One particular propagule is seed.

“Growing medium” can be soil or an artificial growing medium. Preferably it is soil.

According to the present invention, “increased crop yield” of a plant means that the yield of a product (crop) of the respective plant is increased by a measurable amount over the yield of the same product (crop) of the same plant variety produced under the same conditions, but the propagules of which this is growing not having been treated with the at least one GABA antagonist insecticide. According to the present invention, it is preferred that the yield be increased by at least 2%, more preferred by at least 3%, even more preferred by at least 4%, still more preferred by at least 5% and specifically by at least 8%. The yield is generally determined in form of the weight of the respective crop. It is in general not determined from a single plant, but is the value obtained from plants growing on an area of a certain dimension (e.g. 1 ha).

The below remarks as to preferred embodiments of the insecticides, to their preferred use and methods of using them are to be understood either each on their own or preferably in combination with each other.

In one preferred embodiment, the invention relates to the use of at least one insecticide selected from GABA antagonists for increasing the crop yield of at least one plant variety which is growing in a medium with a suboptimal nitrogen content.

Accordingly, the invention relates in another preferred embodiment to a method for increasing the crop yield of at least one plant variety which is growing in a medium with a suboptimal nitrogen content, which method comprises treating the plant propagules from which the plant is to grow with at least one insecticide selected from GABA antagonists.

A “suboptimal nitrogen content” is a nitrogen content which is below the concentration of nitrogen in the growing medium which leads to a maximum crop yield. This value is of course relative and depends on a multiplicity of factors such as the presence and amount of other nutrients, the composition of the growing medium in general, its pH, water conditions, growing stage of the plant (for example at the time of sowing the optimal nitrogen content is lower than later on), from the plant itself (for example some plants necessitate a higher nitrogen content at the beginning of the vegetation period, others necessitate a higher content during the stem elongation phase etc.) the presence of microorganisms in the growing medium (microorganisms which transform organic nitrogen compounds or air nitrogen into a form which can be taken up by the plants) etc. A general overview of an optimal nitrogen content in soil depending on culture plants can be found in Faustzahlen für die Landwirtschaft, 13. edition, edited by Kuratorium für Technik and Bauwesen in der Landwirtschaft e.V., Darmstadt, Germany.

Practically speaking, a soil has suboptimal nitrogen content in the terms of the present invention if the soil is supplied with less then 70% of standard nitrogen fertilization, preferably with less then 50% of standard nitrogen fertilization and in particular with less then 30% of standard nitrogen fertilization relative to the total need for nitrogen of the specific crop (for standard amounts of nitrogen fertilization see for example the above-cited Faustzahlen für die Landwirtschaft). If the crop is planted in the open field the level of fertilization includes the residual nitrogen from the previous crop in the soil in a depth from 0-90 cm.

For example a suboptimal nitrogen content is less than 23 g per m³ (corresponds to less than 200 kg/ha considering a depth of 0-90 cm), preferably less than 17 g per m³ (corresponds to less than 150 kg/ha considering a depth of 0-90 cm), more preferably less than 11 g per m³ (corresponds to less than 100 kg/ha considering a depth of 0-90 cm), even more preferably less than 9 g per m³ (corresponds to less than 80 kg/ha considering a depth of 0-90 cm), in particular less than 8 g per m³ (corresponds to less than 70 kg/ha considering a depth of 0-90 cm), e.g. less than 7, less than 6 or less than 5 g per m³.

The term “nitrogen” refers to any nitrogen compound which serves as nutrient fort the plant and can be taken up via the plant's roots. These are in general compounds of rather inorganic character, such as ammonium salts, urea and nitrates, while organic nitrogen compounds generally cannot be taken up as such and must first be converted into mineral nitrogen compounds by microorganisms. Thus, the term nitrogen content refers to the content of inorganic nitrogen compounds and in particular of ammonium compounds and nitrates.

The GABA antagonists are preferably selected from acetoprole, endosulfan, vaniliprole, pyrafluprole, pyriprole, the phenylpyrazole compound of the formula II

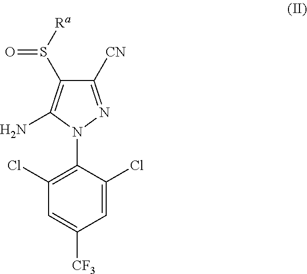

where R^{a} is C₁-C₄-alkyl or C₁-C₄-haloalkyl;
or an agriculturally acceptable salt thereof; and the phenylpyrazole compound of the formula III

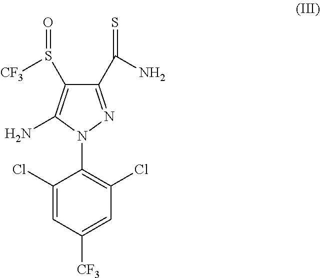

or an agriculturally acceptable salt thereof.

The organic moieties mentioned in the above definitions of the variables are—like the term halogen—collective terms for individual listings of the individual group members. The prefix Cₙ-Cₘ indicates in each case the possible number of carbon atoms in the group.

Halogen will be taken to mean fluoro, chloro, bromo and iodo, preferably fluoro, chloro, and bromo and in particular fluoro and chloro.

C₁-C₄-alkyl is a linear or branched alkyl group having 1 to 4 carbon atoms. Examples are methyl, ethyl, propyl, isopropyl, n-butyl, sec-butyl, isobutyl and tert-butyl.

C₁-C₄-haloalkyl is a linear or branched alkyl group having 1 to 4 carbon atoms, as de-fined above, wherein at least one hydrogen atom is replaced by a halogen atom. Examples are chloromethyl, bromomethyl, dichloromethyl, trichloromethyl, fluoromethyl, difluoromethyl, trifluoromethyl, chlorofluoromethyl, dichlorofluoromethyl, chlorodi-fluoromethyl, 1-chloroethyl, 1-bromoethyl, 1-fluoroethyl, 2-fluoroethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl, pentafluoroethyl and the like.

Owing to the basic nitrogen atoms in the azole moieties, some of the GABA antagonist insecticides (for example compounds II and III described above) are capable of forming salts or adducts with inorganic or organic aids or with metal ions. They can be formed in a customary method, e.g. by reacting the compounds with an acid of the anion in question.

Suitable agriculturally useful salts are especially the salts of those cations or the acid addition salts of those acids the cations and anions of which do not have any adverse effect on the action of the compounds according to the present invention. Suitable cations are in particular the ions of the alkali metals, preferably lithium, sodium and potassium, of the alkaline earth metals, preferably calcium, magnesium and barium, and of the transition metals, preferably manganese, copper, zinc and iron, and also ammonium (NH₄⁺) and substituted ammonium in which one to four of the hydrogen atoms are replaced by C₁-C₄-alkyl, C₁-C₄-hydroxyalkyl, C₁-C₄-alkoxy, C₁-C₄-alkoxy-C₁-C₄-alkyl, hydroxy-C₁-C₄-alkoxy-C₁-C₄-alkyl, phenyl or benzyl. Examples of substituted ammonium ions comprise methylammonium, isopropylammonium, dimethylammonium, diisopropylammonium, trimethylammonium, tetramethylammonium, tetraethylammonium, tetrabutylammonium, 2-hydroxyethylammonium, 2-(2-hydroxyethoxy)ethyl-ammonium, bis(2-hydroxyethyl)ammonium, benzyltrimethylammonium and benzyl-triethylammonium, furthermore phosphonium ions, sulfonium ions, preferably tri(C₁-C₄-alkyl)sulfonium, and sulfoxonium ions, preferably tri(C₁-C₄-alkyl)sulfoxonium.

Anions of useful acid addition salts are primarily chloride, bromide, fluoride, hydrogen sulfate, sulfate, dihydrogen phosphate, hydrogen phosphate, phosphate, nitrate, hydrogen carbonate, carbonate, hexafluorosilicate, hexafluorophosphate, benzoate, and the anions of C₁-C₄-alkanoic acids, preferably formiate, acetate, propionate and butyrate. They can be formed by reacting the compounds of the formulae I or II or III (as to compounds II and III see below) with an acid of the corresponding anion, preferably of hydrochloric acid, hydrobromic acid, sulfuric acid, phosphoric acid or nitric acid.

Preferably, the GABA antagonists are selected from compounds of formula II.

In compounds II, R^{a} is preferably ethyl or trifluoromethyl. The compound where R^{a} is ethyl is also known under the common name ethiprole and the compound where R^{a} is trifluoromethyl is known under the common name fipronil. More preferably, R^{a} is preferably trifluoromethyl. Thus, the GABA antagonist insecticide is in particular fipronil.

GABA antagonists and methods for producing them are generally known. For instance, the commercially available compounds may be found in The Pesticide Manual, 13^{th} Edition, British Crop Protection Council (2003) among other publications.

As a matter of course, the at least one insecticide is used in an effective and non-phytotoxic amount. This means that it is used in a quantity which allows to obtain the desired effect but which does not give rise to any phytotoxic symptom on the plant raised from the treated propagule.

The plants to be treated are generally plants of economic importance. Thus, they are preferably selected from agricultural, silvicultural and ornamental plants.

In one preferred embodiment of the invention, the plant is an agricultural plant. Agricultural plants are plants of which a part or all is harvested or cultivated on a commercial scale or which serve as an important source of feed, food, fibers (e.g. cotton, linen), combustibles (e.g. wood, bioethanol, biodiesel, biomass) or other chemical compounds. Agricultural plants also encompass horticultural plants, i.e. plants grown in gardens (and not on fields), such as certain fruits and vegetables. Examples for agricultural plants are soybean, corn (maize), wheat, triticale, barley, oats, rye, rape, such as canola/oilseed rape, millet (sorghum), rice, sunflower, cotton, sugar beets, pome fruit, stone fruit, citrus, bananas, strawberries, blueberries, almonds, grapes, mango, papaya, peanuts, potatoes, tomatoes, peppers, cucurbits, cucumbers, melons, watermelons, garlic, onions, carrots, cabbage, beans, peas, lentils, alfalfa (lucerne), trefoil, clovers, flax, elephant grass (Miscanthus), grass, lettuce, sugar cane, tea, tobacco and coffee.

Preferably, the agricultural plants to be treated according to the invention are non-leguminous plants.

Preferably, the agricultural plants are selected from corn, wheat, triticale, barley, oats, rye, rape, millet, rice, sunflower, cotton, sugar beets, potatoes, tomatoes, peppers, cucurbits, cucumbers, melons, watermelons, garlic, onions, carrots, cabbage, lettuce, sugar cane, tea, tobacco and coffee and more preferably from corn (maize), wheat, triticale, barley, oats, rye, rape, such as canola/oilseed rape, millet (sorghum), rice, sunflower and sugar cane. In particular, the agricultural plant is wheat.

The plants can be non-transgenic plants or can be plants that have at least one trans-genic event. In one embodiment, the plant is a transgenic plant having a transgenic event that confers resistance to a pesticide. Examples for transgenic plants having a pesticide resistance are transgenic crops which are resistant to herbicides from the group consisting of the sulfonylureas (see for example EP-A-0257993, U.S. Pat. No. 5,013,659), imidazolinones (see for example U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073), glufosinate-type (see for example EP-A-0242236, EP-A-242246) or glyphosate-type (see for example WO 92/00377) or plants resistant towards herbicides selected from the group of cyclohexadienone/aryloxyphenoxypropionic acid herbicides (see for example U.S. Pat. No. 5,162,602, U.S. Pat. No. 5,290,696, U.S. Pat. No. 5,498,544, U.S. Pat. No. 5,428,001, U.S. Pat. No. 6,069,298, U.S. Pat. No. 6,268,550, U.S. Pat. No. 6,146,867, U.S. Pat. No. 6,222,099, U.S. Pat. No. 6,414,222) or transgenic crop plants, for example cotton, with the capability of producing Bacillus thuringiensis toxins (Bt toxins) which make the plants resistant to certain pests (see for example EP-A-0142924, EP-A-0193259).

It is to be understood, however, that when the plant is a transgenic plant, the trans-genic events that are present in the plant are by no means limited to those that provide pesticide resistance, but can include any transgenic event. In fact, the use of “stacked” transgenic events in a plant is also contemplated.

The treatment of a plant's propagation material, such as a seed, with the at least one GABA antagonist insecticide can be accomplished in several ways. The insecticide may be applied directly to the propagules, especially the seed, and/or to the soil in which the seed is to be planted, for example, at the time of planting along with the seed (for example in-furrow application). Preferably, the least one GABA antagonist insecticide is applied directly to the propagules, especially the seed.

The at least one GABA antagonist insecticide can be applied as such, in the form of its formulations or the application form prepared therefrom, for example in the form of directly sprayable solutions, powders, suspensions or dispersions, including highly concentrated aqueous, oily or other suspensions or dispersions, emulsions, oil dispersions, pastes, dusts, compositions for broadcasting or granules. Application is usually carried out by spraying, atomizing, dusting, broadcasting or watering. The application forms and methods depend on the intended uses; in each case, they should ensure the finest possible distribution of the active compounds.

Depending on the embodiment in which the ready-to-use preparations of the at least one GABA antagonist insecticide is present, they comprise one or more liquid or solid carriers, if appropriate surfactants and if appropriate further auxiliaries customary for formulating crop protection agents. The recipes for such formulations are familiar to the person skilled in the art.

Aqueous application forms can be prepared, for example, from emulsion concentrates, suspensions, pastes, wettable powders or water-dispersible granules by addition of water. To prepare emulsions, pastes or oil dispersions, the active component(s), as such or dissolved in an oil or solvent, can be homogenized in water by means of a wetting agent, tackifier, dispersant or emulsifier. However, it is also possible to prepare concentrates composed of active substance, wetting agent, tackifier, dispersant or emulsifier and, if appropriate, solvent or oil, such concentrates being suitable for dilution with water.

The concentrations of the at least one GABA antagonist insecticide in the ready-to-use preparations can be varied within relatively wide ranges. In general, they are between 0.0001 and 10%, preferably between 0.01 and 1% (% by weight total content of active compound(s), based on the total weight of the ready-to-use preparation).

The at least one GABA antagonist insecticide may also be used successfully in the ultra-low-volume process (ULV), it being possible to employ formulations comprising more than 95% by weight of total active compound, or even to apply the active compounds without additives.

Oils of various types, wetting agents, adjuvants, herbicides, fungicides, insecticides different from the at least one GABA antagonist insecticide, nematicides, other pesticides, such as bactericides and/or growth regulators may be added to the active compounds, even, if appropriate, not until immediately prior to use (tank mix). These agents can be mixed in a weight ratio of from 1:100 bis 100:1, preferably from 1:10 to 10:1 with the at least one GABA antagonist insecticide employed according to the invention.

Adjuvants are for example: modified organic polysiloxanes, e.g. Break Thru S 240®; alkohol alkoxylates, e.g. Atplus 245®, Atplus MBA 1303®, Plurafac LF 300® and Lutensol ON 30®; EO-PO block copolymers, e.g. Pluronic RPE 2035® and Genapol B®; alkohol ethoxylates, e.g. Lutensol XP 80®; and sodium dioctylsulfosuccinate, e.g. Leophen RA®.

Suitable insecticides are for example:

A.1. Organo(thio)phosphates: acephate, azamethiphos, azinphos-ethyl, azinphos-methyl, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, flupyrazophos, fosthiazate, heptenophos, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, vamidothion;

A.2. Carbamates: aldicarb, alanycarb, bendiocarb, benfuracarb, butocarboxim, butoxy-carboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb, triazamate;

A.3. Pyrethroids: acrinathrin, allethrin, d-cis-trans allethrin, d-trans allethrin, bifenthrin, bioallethrin, bioallethrin S-cylclopentenyl, bioresmethrin, cycloprothrin, cyfluthrin, beta-, yfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate, flucythrinate, flumethrin, tau-fluvalinate, halfenprox, imiprothrin, permethrin, phenothrin, prallethrin, resmethrin, RU 15525, silafluofen, tefluthrin, tetramethrin, tralomethrin, transfluthrin, ZXI 8901;

A.4. Juvenile hormone mimics: hydroprene, kinoprene, methoprene, fenoxycarb, pyriproxyfen;

A.5. Nicotinic receptor agonists/antagonists compounds: acetamiprid, bensultap, cartap hydrochloride, clothianidin, dinotefuran, imidacloprid, thiamethoxam, nitenpyram, nicotine, spinosad (allosteric agonist), thiacloprid, thiocyclam, thiosultap-sodium, and AKD1022.

A.6. Chloride channel activators: abamectin, emamectin benzoate, milbemectin, lepimectin;

A.7. METI I compounds: fenazaquin, fenpyroximate, pyrimidifen, pyridaben, tebufenpyrad, tolfenpyrad, flufenerim, rotenone;

A.8. METI II and III compounds: acequinocyl, fluacyprim, hydramethylnon;

A.9. Uncouplers of oxidative phosphorylation: chlorfenapyr, DNOC;

A.10. Inhibitors of oxidative phosphorylation: azocyclotin, cyhexatin, diafenthiuron, fenbutatin oxide, propargite, tetradifon;

A.11. Moulting disruptors: cyromazine, chromafenozide, halofenozide, methoxy-fenozide, tebufenozide;

A.12. Synergists: piperonyl butoxide, tribufos;

A.13. Sodium channel blocker compounds: indoxacarb, metaflumizone;

A.14. Fumigants: methyl bromide, chloropicrin sulfuryl fluoride;

A.15. Selective feeding blockers: crylotie, pymetrozine, flonicamid;

A.16. Mite growth inhibitors: clofentezine, hexythiazox, etoxazole;

A.17. Chitin synthesis inhibitors: buprofezin, bistrifluron, chlorfluazuron, diflubenzuron, flucycloxuron, flufenoxuron, hexaflumuron, lufenuron, novaluron, noviflumuron, teflubenzuron, triflumuron;

A.18. Lipid biosynthesis inhibitors: spirodiclofen, spiromesifen, spirotetramat;

A.19. octapaminergic agonsits: amitraz;

A.20. ryanodine receptor modulators: flubendiamide;

A.21. Various: aluminium phosphide, amidoflumet, benclothiaz, benzoximate, bifenazate, borax, bromopropylate, cyanide, cyenopyrafen, cyflumetofen, chinomethionate, dicofol, fluoroacetate, phosphine, pyridalyl, pyrifluquinazon, sulfur, tartar emetic;

A.22. N—R′-2,2-dihalo-1-R″cyclo-propanecarboxamide-2-(2,6-dichloro-α,α,α-tri-fluoro-p-tolyl)hydrazone or N—R′-2,2-di(R′″)propionamide-2-(2,6-dichloro-α,α,α-trifluoro-p-tolyl)-hydrazone, wherein R′ is methyl or ethyl, halo is chloro or bromo, R″ is hydrogen or methyl and R′″ is methyl or ethyl;

A.23. Anthranilamides: chloranthraniliprole, the compound of formula Γ²

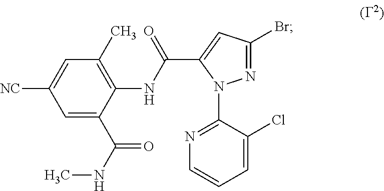

A.24. Malononitrile compounds: CF₃(CH₂)₂C(CN)₂CH₂(CF₂)₃CF₂H, CF₃(CH₂)₂C(CN)₂CH₂(CF₂)₅CF₂H, CF₃(CH₂)₂C(CN)₂(CH₂)₂C(CF₃)₂F, CF₃(CH₂)₂C(CN)₂(CH₂)₂(CF₂)₃CF₃, CF₂H(CF₂)₃CH₂C(CN)₂CH₂(CF₂)₃CF₂H, CF₃(CH₂)₂C(CN)₂CH₂(CF₂)₃CF₃, CF₃(CF₂)₂CH₂C(CN)₂CH₂(CF₂)₃CF₂H, CF₃CF₂CH₂C(CN)₂CH₂(CF₂)₃CF₂H, 2-(2,2,3,3,4,4,5,5-octafluoropentyl)-2-(3,3,4,4,4-pentafluorobutyl)-malonodinitrile, and CF₂HCF₂CF₂CF₂CH₂C(CN)₂CH₂CH₂CF₂CF₃;

A.25. Microbial disruptors: Bacillus thuringiensis subsp. Israelensi, Bacillus sphaericus, Bacillus thuringiensis subsp. Aizawai, Bacillus thuringiensis subsp. Kurstaki, Bacillus thuringiensis subsp. Tenebrionis;

The commercially available compounds of the group A may be found in The Pesticide Manual, 13^{th} Edition, British Crop Protection Council (2003) among other publications.

Thioamides of formula Γ¹ and their preparation have been described in WO 98/28279. Lepimectin is known from Agro Project, PJB Publications Ltd, November 2004. Benclothiaz and its preparation have been described in EP-A1 454621. Methidathion and Paraoxon and their preparation have been described in Farm Chemicals Handbook, Volume 88, Meister Publishing Company, 2001. Acetoprole and its preparation have been described in WO 98/28277. Metaflumizone and its preparation have been described in EP-A1 462 456. Flupyrazofos has been described in Pesticide Science 54, 1988, p. 237-243 and in U.S. Pat. No. 4,822,779. Pyrafluprole and its preparation have been de-scribed in JP 2002193709 and in WO 01/00614. Pyriprole and its preparation have been described in WO 98/45274 and in U.S. Pat. No. 6,335,357. Amidoflumet and its preparation have been described in U.S. Pat. No. 6,221,890 and in JP 21010907. Flufenerim and its preparation have been described in WO 03/007717 and in WO 03/007718. AKD 1022 and its preparation have been described in U.S. Pat. No. 6,300,348. Chloranthraniliprole has been described in WO 01/70671, WO 03/015519 and WO 05/118552. Anthranilamide derivatives of formula Γ² have been described in WO 01/70671, WO 04/067528 and WO 05/118552. Cyflumetofen and its preparation have been described in WO 04/080180. The aminoquinazolinone compound pyrifluquinazon has been de-scribed in EPA 109 7932. The malononitrile compounds CF₃(CH₂)₂C(CN)₂CH₂(CF₂)₃CF₂H, CF₃(CH₂)₂C(CN)₂CH₂(CF₂)₅CF₂H, CF₃(CH₂)₂C(CN)₂(CH₂)₂C(CF₃)₂F, CF₃(CH₂)₂C(CN)₂(CH₂)₂(CF₂)₃CF₃, CF₂H(CF₂)₃CH₂C(CN)₂CH₂(CF₂)₃CF₂H, CF₃(CH₂)₂C(CN)₂CH₂(CF₂)₃CF₃, CF₃(CF₂)₂CH₂C(CN)₂CH₂(CF₂)₃CF₂H, CF₃CF₂CH₂C(CN)₂CH₂(CF₂)₃CF₂H, 2-(2,2,3,3,4,4,5,5-octafluoropentyl)-2-(3,3,4,4,4-pentafluorobutyl)-malonodinitrile, and CF₂HCF₂CF₂CF₂CH₂C(CN)₂CH₂CH₂CF₂CF₃ have been described in WO 05/63694.

Suitable fungicides are for example:

B.1 Strobilurines

azoxystrobin, dimoxystrobin, enestroburin, fluoxastrobin, kresoxim-methyl, methominostrobin, orysastrobin, picoxystrobin, pyraclostrobin, pyribencarb, trifloxystrobin, 2-(2-(6-(3-chloro-2-methyl-phenoxy)-5-fluor-pyrimidin-4-yloxy)-phenyl)-2-methoxyimino-N-methyl-acetamide, methyl 2-(ortho-((2,5-dimethylphenyl-oxymethylen)phenyl)-3-methoxy-acrylate, methyl 3-methoxy-2-(2-(N-(4-methoxy-phenyl)-cyclopropancarboximidoylsulfanylmethyl)-phenyl)-acrylater;

B.2 Carboxylic acid amides

B.2.1 Carboxylic acid anilides: benalaxyl, benalaxyl-M, benodanil, bixafen, boscalid, carboxin, fenfuram, fenhexamid, flutolanil, furametpyr, isotianil, kiralaxyl, mepronil, metalaxyl, ofurace, oxadixyl, oxycarboxin, penthiopyrad, tecloftalam, thifluzamide, tiadinil, 2-amino-4-methyl-thiazol-5-carboxylic acid anilide, 2-chloro-N-(1,1,3-trimethyl-indan-4-yl)-nicotinamide, N-(3′,4′-dichloro-5-fluoro-biphenyl-2-yl)-3-difluoromethyl-1-methyl-1H-pyrazol-4-carboxylic acid amide, 5-fluoro-1,3-dimethyl-1H-pyrazol-4-carboxylic [2-(1,3-dimethyl-butyl)-phenyl]-amide, N-(4′-chloro-3′,5-difluoro-biphenyl-2-yl)-3-difluoromethyl-1-methyl-1H-pyrazol-4-carboxylic amide, N-(4′-chloro-3′,5-difluoro-biphenyl-2-yl)-3-trifluormethyl-1-methyl-1H-pyrazol-4-carboxylic acid amide, N-(3′,4′-dichloro-5-fluoro-biphenyl-2-yl)-3-trifluormethyl-1-methyl-1H-pyrazol-4-carboxylic acid amide, N-(3′,5-difluoro-4′-methyl-biphenyl-2-yl)-3-difluoromethyl-1-methyl-1H-pyrazol-4-carboxylic acid amide, N-(3′,5-difluoro-4′-methyl-biphenyl-2-yl)-3-trifluoromethyl-1-methyl-1H-pyrazol-4-carboxylic acid amide, N-(2-bicyclopropyl-2-yl-phenyl)-3-difluoromethyl-1-methyl-1H-pyrazol-4-carboxylic acid amide, N-(cis-2-bicyclopropyl-2-yl-phenyl)-3-difluoromethyl-1-methyl-1H-pyrazol-4-carboxylic acid amide, N-(trans-2-bicyclopropyl-2-yl-phenyl)-3-difluoromethyl-1-methyl-1H-pyrazol-4-carboxylic acid amide,

B.2.2 Carboxylic acid morpholides: dimethomorph, flumorph;

B.2.3 Benzoic acid amides: flumetover, fluopicolide, fluopyram, zoxamide, N-(3-ethyl-3,5,5-trimethyl-cyclohexyl)-3-formylamino-2-hydroxy-benzamide;

B.2.4 Other carbocxylic amides: carpropamid, diclocymet, mandipropamid, oxytetracyclin, silthiofam, N-(6-methoxy-pyridin-3-yl)cyclopropanecarboxylic acid amide;

B.3 Azoles

B.3.1 Triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazol, myclobutanil, oxpoconazol, paclobutrazol, penconazole, propiconazole, prothioconazole, simeconazole, tebuconazole, tetraconazole, triadimefon, triadimenol, triticonazole, uniconazol, 1-(4-chloro-phenyl)-2-([1,2,4]triazol-1-yl)-cycloheptanol;

B.3.2 Imidazoles: cyazofamid, imazalil, imazalil-sulfate, pefurazoate, prochloraz, triflumizole;

B.3.3 Benzimidazoles: benomyl, carbendazim, fuberidazole, thiabendazole;

B.3.4 Others: ethaboxam, etridiazole, hymexazole, 1-(4-chloro-phenyl)-1-(propin-2-yloxy)-3-(4-(3,4-dimethoxy-phenyl)-isoxazol-5-yl)-propan-2-one;

B.4 Nitrogen-containing heterocyclic compounds

B.4.1 Pyridines: fluazinam, pyrifenox, 3-[5-(4-chloro-phenyl)-2,3-dimethyl-isoxazolidin-3-yl]-pyridine, 2,3,5,6-tetrachloro-4-methansulfonyl-pyridine, 3,4,5-trichloro-pyridine-2,6-dicarbonitril, N-(1-(5-bromo-3-chloro-pyridin-2-yl)-ethyl)-2,4-dichloro-nicotinamide, N-(5-bromo-3-chloro-pyridin-2-yl)-methyl)-2,4-dichloro-nicotinamide;

B.4.2 Pyrimidines: bupirimate, cyprodinil, diflumetorim, fenarimol, ferimzone, mepanipyrim, nitrapyrin, nuarimol, pyrimethanil;

B.4.3 Pyrroles: fludioxonil, fenpiclonil;

B.4.4 Morpholines: aldimorph, dodemorph, dodemorph-acetate, fenpropimorph, tridemorph;

B.4.5 Dicarboximides: fluoroimid, iprodione, procymidone, vinclozolin;

B.4.6 Others: acibenzolar-S-methyl, amisulbrom, anilazin, blasticidin-S, captafol, captan, chinomethionat, dazomet, debacarb, diclomezine, difenzoquat, difenzoquat-methylsuiphat, famoxadone, fenamidone, fenoxanil, fenpropidin, folpet, octhilinone, oxolinsäure, piperalin, probenazole, proquinazid, pyroquilon, quinoxyfen, triazoxid, tricyclazole, triforine, 5-chloro-7-(4-methyl-piperidin-1-yl)-6-(2,4,6-trifluoro-phenyl)-[1,2,4]triazolo[1,5-a]pyrimidine, 2-butoxy-6-iodo-3-propyl-chromen-4-on;

B.5 Carbamates and Dithiocarbamate

B.5.1 Thio- and Dithiocarbamates: ferbam, mancozeb, maneb, metam, methasulphocarb, metiram, propineb, thiram, zineb, ziram;

B.5.2 Carbamates: diethofencarb, benthiavalicarb, iprovalicarb, propamocarb, propamocarb hydrochloride, valiphenal, N-(1-(1-(4-cyanophenyl)ethansulfonyl)-but-2-yl)carb-aminic acid (4-fluorophenyl)ester;

B.6 Other fungicides

B.6.1 Guanidines: dodine, dodine free base, guazatine, guazatine-acetate, iminoctadine, iminoctadine-triacetate, iminoctadine-tris(albesilate);

B.6.2 Antibiotics: kasugamycin, kasugamycin-hydrochloride-hydrate, polyoxine, streptomycin, validamycin A;

B.6.3 Nitrophenylderivatives:

binapacryl, dicloran, dinobuton, dinocap, nitrothal-isopropyl, tecnazen;

B.6.4 Organometal compounds: fentin salts such as fentin-acetate, fentin-chloride, fentin-hydroxide;

B.6.5 Sulfur-containing heterocyclic compounds: isoprothiolane, dithianon;

B.6.6 Organophosphorus compounds: edifenphos, fosetyl, fosetyl-aluminium, iprobenfos, pyrazophos, tolclofos-methyl;

B.6.7 Organochlorine compounds: chlorothalonil, dichlofluanid, dichlorophen, flusulfamide, hexachlorbenzene, pencycuron, pentachlorophenol and salts thereof, phthalid, quintozene, thiophanate-methyl, tolylfluanid, N-(4-chloro-2-nitro-phenyl)-N-ethyl-4-methyl-benzene sulfonamide;

B.6.8 Inorganic compounds: phosphorous acid and salts thereof, sulfur, Bordeaux mixture, copper salts such as copper acetate, copper hydroxide, copper oxychloride, basic copper sulfate;

B.6.9 Others: biphenyl, bronopol, cyflufenamide, cymoxanil, diphenylamine, metrafenone, mildiomycin, oxin-copper, prohexadione-calcium, spiroxamine, tolylfluanid, N-(cyclopropylmethoxyimino-(6-difluoromethoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N-methylformamidine, N′-(4-(4-fluoro-3-trifluoromethyl-phenoxy)-2,5-dimethyl-phenyl)-N-ethyl-N-methylformamidine, N′-(2-methyl-5-trifluoromethyl-4-(3-trimethyl-silanyl-propoxy)-phenyl)-N-ethyl-N-methylformamidine, N′-(5-Difluoromethyl-2-methyl-4-(3-trimethylsilanyl-propoxy)-phenyl)-N-ethyl-N-methylformamidine.

The formulations are prepared in a known manner, for example by extending the active compounds with solvents and/or carriers, if desired with the use of surfactants, i.e. emulsifiers and dispersants. Solvents/carriers suitable for this purpose are essentially:
water, aromatic solvents (for example Solvesso products, xylene), paraffins (for example mineral oil fractions), alcohols (for example methanol, butanol, pentanol, benzyl alcohol), ketones (for example cyclohexanone, methyl hydroxybutyl ketone, diacetone alcohol, mesityl oxide, isophorone), lactones (for example gamma-butyrolactone), pyrrolidones (pyrrolidone, N-methylpyrrolidone, N-ethylpyrrolidone, n-octylpyrrolidone), acetates (glycol diacetate), glycols, dimethyl fatty acid amides, fatty acids and fatty acid esters. In principle, solvent mixtures may also be used.
Carriers such as ground natural minerals (for example kaolins, clays, talc, chalk) and ground synthetic minerals (for example finely divided silica, silicates); emulsifiers such as nonionic and anionic emulsifiers (for example polyoxyethylene fatty alcohol ethers, alkylsulfonates and arylsulfonates), and dispersants such as lignosulfite waste liquors and methylcellulose.

Suitable surfactants are alkali metal salts, alkaline earth metal salts and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, poly-oxyethylene octylphenol ether, ethoxylated isooctylphenol, octylphenol, nonylphenol, alkylphenyl polyglycol ether, tributylphenyl polyglycol ether, tristerylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Suitable for the preparation of directly sprayable solutions, emulsions, pastes or oil dispersions are mineral oil fractions of medium to high boiling point, such as kerosene or diesel oil, furthermore coal tar oils and oils of vegetable and animal origin, aliphatic, cyclic and aromatic hydrocarbons, for example toluene, xylene, paraffin, tetrahydro-naphthalene, alkylated naphthalenes or their derivatives, methanol, ethanol, propanol, butanol, cyclohexanol, cyclohexanone, mesityl oxide, isophorone, strongly polar solvents, for example dimethyl sulfoxide, 2-yrrolidone, N-methylpyrrolidone, butyrolactone, or water.

Powders, compositions for broadcasting and dusts can be prepared by mixing or jointly grinding the active substances with a solid carrier.

Granules, for example coated granules, impregnated granules and homogeneous granules, can be prepared by binding the active compounds onto solid carriers. Solid carriers are, for example, mineral earths such as silica gels, silicates, talc, kaolin, atta-clay, limestone, lime, chalk, bole, loess, clay, dolomite, diatomaceous earth, calcium sulfate, magnesium sulfate, magnesium oxide, ground synthetic materials, fertilizers such as, for example, ammonium sulfate, ammonium phosphate, ammonium nitrate, ureas and plant products such as cereal meal, tree bark meal, wood meal and nutshell meal, cellulose powder and other solid carriers.

Formulations for seed treatment can further comprise binders and/or gelling agents and optionally colorants.

In general, the formulations comprise between 0.01 and 95% by weight, preferably between 0.1 and 90% by weight, in particular 5 to 50% by weight, of the active compound(s) (total weight). In this context, the active compound(s) is/are employed in a purity of from 90% to 100%, preferably 95% to 100% (according to NMR spectrum).

After two- to ten-fold dilution, formulations for seed treatment comprise 0.01 to 60% by weight, preferably 0.1 to 40% by weight of the active compounds (total weight) in the ready-to-use preparations.

Examples of formulations are:

### 1. Products for Dilution in Water

I) Water-Soluble Concentrates (SL, LS)

10 parts by weight of active compounds are dissolved in 90 parts by weight of water or a water-soluble solvent. Alternatively, wetting agents or other adjuvants are added. Upon dilution in water, the active compound dissolves. The ready formulation contains 10% by weight of active ingredients.

II) Dispersible Concentrates (DC)

20 parts by weight of active compounds are dissolved in 70 parts by weight of cyclohexanone with addition of 10 parts by weight of a dispersant, for example polyvinylpyrrolidone. The active ingredients are contained in 20% by weight. Upon dilution in water, a dispersion results.

III) Emulsifiable Concentrates (EC)

15 parts by weight of active compounds are dissolved in 75 parts by weight of xylene with addition of calcium dodecylbenzenesulfonate and castor oil ethoxylate (in each case 5 parts by weight). The active ingredients are contained in 15% by weight. Upon dilution in water, an emulsion results.

IV) Emulsions (EW, EO, ES)

25 parts by weight of active compounds are dissolved in 35 parts by weight of xylene with addition of calcium dodecylbenzenesulfonate and castor oil ethoxylate (in each case 5 parts by weight). This mixture is introduced into 30 parts by weight of water by means of an emulsifier (Ultraturrax) and made into a homogeneous emulsion. The active ingredients are contained in 25% by weight. Upon dilution in water, an emulsion results.

V) Suspensions (SC, OD, FS)

20 parts by weight of active compounds are comminuted in a stirred ball mill with addition of 10 parts by weight of dispersants, wetting agents and 70 parts by weight of water or an organic solvent to give a fine suspension of active compound. The active ingredients are contained in 20% by weight. Upon dilution in water, a stable suspension of the active compound results.

VI) Water-Dispersible and Water-Soluble Granules (WG, SG)

50 parts by weight of active compounds are ground finely with addition of 50 parts by weight of dispersants and wetting agents and made into water-dispersible or water-soluble granules by means of technical apparatuses (for example extrusion, spray tower, fluidized bed). The active ingredients are contained in 50% by weight. Upon dilution in water, a stable dispersion or solution of the active compound results.

VII) Water-Dispersible and Water-Soluble Powders (WP, SP, SS, WS)

75 parts by weight of active compounds are ground in a rotor-stator mill with addition of 25 parts by weight of dispersants, wetting agents and silica gel. The active ingredients are contained in 75% by weight. Upon dilution in water, a stable dispersion or solution of the active compound results.

VIII) Gel Formulations (GF)

20 parts by weight of active compounds, 10 parts by weight of dispersants, 1 part by weight of gelling agent and 70 parts by weight of water or an organic solvent are ground in a ball mill to give a finely divided suspension. Upon dilution in water, a stable suspension of the active compounds results.

### 2. Products for Direct Application

IX) Dusts (DP, DS)

5 parts by weight of active compounds are ground finely and mixed intimately with 95 parts by weight of finely particulate kaolin. This gives a dust with 5% by weight of active ingredients.

X) Granules (GR, FG, GG, MG)

0.5 part by weight of active compounds is ground finely and combined with 95.5 parts by weight of carriers. Current methods are extrusion, spray drying or the fluidized bed. This gives granules for direct application with 0.5% by weight of active ingredients.

XI) ULV solutions (UL)

10 parts by weight of active compounds are dissolved in 90 parts by weight of an organic solvent, for example xylene. This gives a product for direct application with 10% by weight of active ingredients.

Formulations suitable for treating seed are, for example:

I soluble concentrates (SL, in particular LS)
III emulsifiable concentrates (EC)
IV emulsions (EW, EO, in particular ES)
V suspensions (SC, OD, in particular FS)
VI water-dispersible and water-soluble granules (WG, in particular SG)
VII water-dispersible and water-soluble powders (WP, in particular SS and WS)
VIII gel formulations (GF)
IX dusts and dust-like powders (DP, in particular DS)

Preferred formulations to be used for seed treatment are FS formulations. Generally, theses formulations comprise 1 to 800 g/l of active compounds, 1 to 200 g/l of wetting agents, 0 to 200 g/l of antifreeze agents, 0 to 400 g/l of binders, 0 to 200 g/l of colorants (pigments and/or dyes) and solvents, preferably water.

Preferred FS formulations of the active compounds for the treatment of seed usually comprise from 0.5 to 80% of active compounds, from 0.05 to 5% of wetting agent, from 0.5 to 15% of dispersant, from 0.1 to 5% of thickener, from 5 to 20% of antifreeze agent, from 0.1 to 2% of antifoam, from 1 to 20% of pigment and/or dye, from 0 to 15% of tackifier or adhesive, from 0 to 75% of filler/vehicle, and from 0.01 to 1% of preservative.

Suitable pigments or dyes for formulations of the active compounds for the treatment of seed are Pigment blue 15:4, Pigment blue 15:3, Pigment blue 15:2, Pigment blue 15:1, Pigment blue 80, Pigment yellow 1, Pigment yellow 13, Pigment red 112, Pigment red 48:2, Pigment red 48:1, Pigment red 57:1, Pigment red 53:1, Pigment orange 43, Pigment orange 34, Pigment orange 5, Pigment green 36, Pigment green 7, Pigment white 6, Pigment brown 25, Basic violet 10, Basic violet 49, Acid red 51, Acid red 52, Acid red 14, Acid blue 9, Acid yellow 23, Basic red 10, Basic red 108.

Suitable wetting agents and dispersants are in particular the surfactants mentioned above. Preferred wetting agents are alkylnaphthalenesulfonates, such as diisopropyl- or diisobutylnaphthalenesulfonates. Preferred dispersants are nonionic or anionic dispersants or mixtures of nonionic or anionic dispersants. Suitable nonionic dispersants are in particular ethylene oxide/propylene oxide block copolymers, alkylphenol polyglycol ethers and also tristryrylphenol polyglycol ether, for example polyoxyethylene octylphenol ether, ethoxylated isooctylphenol, octylphenol, nonylphenol, alkylphenol polyglycol ethers, tributylphenyl polyglycol ether, tristerylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters and methylcellulose. Suitable anionic dispersants are in particular alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore arylsulfonate/formaldehyde condensates, for example condensates of sulfonated naphthalene and naphthalene derivatives with formaldehyde, condensates of naphthalene or of naphthalenesulfonic acid with phenol and formaldehyde, lignosulfonates, lignosulfite waste liquors, phosphated or sulfated derivatives of methylcellulose and polyacrylic acid salts.

Suitable for use as antifreeze agents are, in principle, all substances which lower the melting point of water. Suitable antifreeze agents include alkanols, such as methanol, ethanol, isopropanol, the butanols, glycol, glycerol, diethylene glycol and the like.

Suitable thickeners are all substances which can be used for such purposes in agrochemical compositions, for example cellulose derivatives, polyacrylic acid derivatives, xanthane, modified clays and finely divided silica.

Suitable for use as antifoams are all defoamers customary for formulating agrochemically active compounds. Particularly suitable are silicone antifoams and magnesium stearate.

Suitable for use as preservatives are all preservatives which can be employed for such purposes in agrochemical compositions. Dichlorophene, isothiazolenes, such as 1,2-benzisothiazol-3(2H)-one, 2-methyl-2H-isothiazol-3-one hydrochloride, 5-chloro-2-(4-chlorobenzyl)-3(2H)-isothiazolone, 5-chloro-2-methyl-2H-isothiazol-3-one, 5-chloro-2-methyl-2H-isothiazol-3-one, 5-chloro-2-methyl-2H-isothiazol-3-one hydrochloride, 4,5-dichloro-2-cyclohexyl-4-isothiazolin-3-one, 4,5-dichloro-2-octyl-2H-isothiazol-3-one, 2-methyl-2H-isothiazol-3-one, 2-methyl-2H-isothiazol-3-one calcium chloride complex, 2-octyl-2H-isothiazol-3-one, and benzyl alcohol hemiformal may be mentioned by way of example.

Adhesives/tackifiers are added to improve the adhesion of the effective components on the seed after treating. Suitable adhesives are EO/PO-based block copolymer surfactants, but also polyvinyl alcohols, polyvinyl pyrrolidones, polyacrylates, polymethacrylates, polybutenes, polyisobutenes, polystyrene, polyethyleneimines, polyethyleneamides, polyethyleneimines (Lupasol®, Polymin®), polyethers and copolymers derived from these polymers.

One example for a suitable gelling agent is carrageen.

Suitable compositions for soil treatment include granules which may be applied in-furrow, as broadcast granules or as impregnated fertilizer granules.

The required application rate of pure active compound, i.e. the at least one GABA antagonist insecticide, without formulation auxiliaries depends on several factors, e.g. on the climatic conditions at the application site and on the application method.

In the treatment of seed, the total amount of the at least one insecticide is from 0.1 to 1000 g/100 kg of seed, preferably from 0.1 to 200 g/100 kg, in particular from 1 to 100 g/100 kg, specifically from 10 to 90 g/100 kg and more specifically from 20 to 70 g/100 kg.

For treating the propagules, in particular the seed, it is possible in principle to use any customary methods for treating or dressing seed, such as, but not limited to, seed dressing, seed coating, seed dusting, seed soaking, seed film coating, seed multilayer coating, seed encrusting, seed dripping, and seed pelleting. Specifically, the treatment is carried out by mixing the seed with the particular amount desired of seed dressing formulations either as such or after prior dilution with water in an apparatus suitable for this purpose, for example a mixing apparatus for solid or solid/liquid mixing partners, until the composition is distributed uniformly on the seed. If appropriate, this is followed by a drying operation.

If the seed is not treated directly, but via the growing medium into which it is planted/sowed, especially via the soil, the latter may be treated by applying to the soil before the propagule is planted/sowed or at the time of planting or sowing along with the propagule (in case of seed sowing this is called in-furrow application) with a suitable amount of the at least one insecticide either as such or after prior dilution with water.

Soil application is for example a suitable method for cereals, cotton, sunflower and trees, in particular if growing in a plantation.

However the direct treatment of the propagules, especially direct seed treatment is preferred.

It was surprisingly found that treating the propagules of a plant with at least one GABA antagonist insecticide leads to an increased crop yield of the plant which grows therefrom as compared to the same plant species growing under the same conditions, however not growing from a propagule which has been treated with the at least one GABA antagonist insecticide. In particular, treating of the propagules of a plant with at least one GABA antagonist insecticide leads to an increased crop yield of the plant growing therefrom which grows in a medium with a suboptimal nitrogen content.

It has to be emphasized that the above effects of the composition of the invention, i.e. enhanced crop yield of the plant, also are present when the plant is not under biotic stress and in particular when the plant is not under insect pressure. It is evident that a plant suffering from insect attack produces a smaller biomass and a smaller crop yield as compared to a plant which has been subjected to curative or preventive treatment against the pest and which can grow without the damage caused by the biotic stress factor. However, the use and the method according to the invention lead to an enhanced crop yield even in the absence of any biotic stress and in particular of any insect pest. This means that the positive effect of the at least one GABA insecticide on the crop yield cannot be explained just by the insecticidal activities of the insecticide, but is based on further activity profiles. But of course, plants under biotic stress can be treated, too, according to the methods of the present invention.

The invention is now further illustrated by the following non-limiting examples.

### EXAMPLES

The N-min analysis method used in the examples determines the content of mineral nitrogen compounds in the soil (0-90 cm depth) at the beginning of the vegetative period. For this purpose, samples are taken in a depth of 0 to 90 cm and mineral nitrogen compounds (ammonium compounds and nitrates) are extracted and analyzed. The method is described in R. Thun et al., “Die Untersuchung von Böden, Methodenbuch Bd. 1, 4th edition 1991, edition VDLUFA (Verband Deutscher Landwirtschaftlicher Untersuchungs- and Forschungsanstalten), Darmstadt, Germany.

### 1. Crop Yield Increase in Spring Wheat

Spring wheat seeds (cultivar Triso) were treated with fipronil (used as commercially available product Regent FS 500; an FS formulation containing 500 g/l of active compound; 50 g per 100 kg seeds) in a HEGE 11 seed treatment apparatus. A part of the seeds remained untreated (control). Five days after the treatment, the seeds were planted near Gommersheim, Palatine, Germany, in a loamy sand with a pH of 6.7, and a tilling depth of 30 cm. Nitrogen content following N-min analysis was 52 kg N per ha in 0 to 90 cm depth. 400 seeds per m² were sown in 1.86 m by 5.5 m plots. Row spacing was 13 cm and seeding depth 3 cm. The treatments were supplied with either standard amount of nitrogen (140 kg N/ha) or reduced amount of nitrogen (30 kg N/ha). 130 days after planting, the wheat grains were harvested and weighed. The results are compiled in table 1 below.

TABLE 1

| | | | Crop yield |
|---|---|---|---|
| Example | Treatment | Soil | [dt*/ha] |
| 1 | (control) | Standard nitrogen | 62.8 |
| 2 | 100 ml/100 kg seeds fipronil | Standard nitrogen | 63.2 |
| 3 | (control) | Reduced nitrogen | 47.0 |
| 4 | 100 ml/100 kg seeds fipronil | Reduced nitrogen | 51.4 |

*dt = deciton = 100 kg

### Example 2

Winter wheat seeds (cultivar Türkis) were treated with fipronil (used as commercially available product Regent FS 500; an FS formulation containing 500 g/l of active ccompound; 25 g per 100 kg seeds) in a HEGE 11 seed treatment apparatus. A part of the seeds remained untreated (control). Two days after the treatment, the seeds were planted in Böhl, Palatine, Germany, in a loamy sand with a pH of 6.7, and a tilling depth of 30 cm. Nitrogen content following N-min analysis was 26 kg N per ha in 0 to 90 cm depth. 400 seeds per m² were sown in 1.86 m by 5.5 m plots. Row spacing was 13 cm and seeding depth 3 cm. The treatments were supplied with either standard amount of nitrogen (180 kg N/ha) or reduced amount of nitrogen (50 kg N/ha). 269 days after planting, the wheat grains were harvested and weighed. The results are compiled in table 2 below.

TABLE 2

| | | | Crop yield |
|---|---|---|---|
| Example | Treatment | Soil | [dt*/ha] |
| 5 | (control) | Standard nitrogen | 87.4 |
| 6 | 50 ml/100 kg seeds fipronil | Standard nitrogen | 87.4 |
| 7 | (control) | Reduced nitrogen | 82.6 |
| 8 | 50 ml/100 kg seeds fipronil | Reduced nitrogen | 86.1 |

*dt = deciton = 100 kg

1-11. (canceled)

12. A method for increasing the crop yield of at least one plant variety, which method comprises treating the plant or its propagules from which the plant is to grow with at least one insecticide selected from GABA antagonists.

13. The method as claimed in claim 12, for increasing the crop yield of at least one plant variety which is growing in soil which is supplied with less than 70% of standard nitrogen fertilization relative to the total need for nitrogen of the specific crop.

14. The method as claimed in claim 13, for increasing the crop yield of at least one plant variety which is growing in soil which is supplied with less than 50% of standard nitrogen fertilization relative to the total need for nitrogen of the specific crop.

15. The method as claimed in claim 12, where the GABA antagonists are selected from acetoprole, endosulfan, vaniliprole, pyrafluprole, pyriprole, the phenylpyrazole compound of the formula II 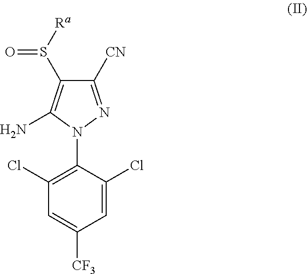
where R^{a} is C₁-C₄-alkyl or C₁-C₄-haloalkyl;
or an agriculturally acceptable salt thereof;
and the phenylpyrazole compound of the formula III 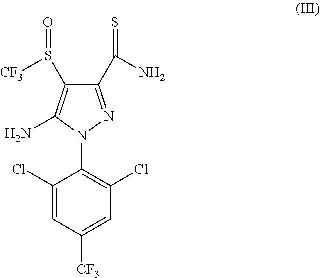
or an agriculturally acceptable salt thereof.

16. The method as claimed in claim 15, where R^{a} is ethyl or trifluoromethyl.

17. The method as claimed in claim 16, where the compound of formula II is fipronil.

18. The method as claimed in claim 12, where the plant is selected from agricultural plants.

19. The method as claimed in claim 18, where the agricultural plant is selected from corn, wheat, triticale, barley, oats, rye, rape, millet, rice, sunflower, cotton, sugar beets, potatoes, tomatoes, peppers, cucurbits, cucumbers, melons, watermelons, garlic, onions, carrots, cabbage, lettuce, sugar cane, tea, tobacco and coffee.

20. The method as claimed in claim 19, where the agricultural plant is wheat.

21. The method as claimed in claim 14, where the GABA antagonist is fipronil and the plant is wheat.

22. The method as claimed in claim 21, for increasing the crop yield of the plant which is growing in soil which is supplied with less than 50% of standard nitrogen fertilization relative to the total need for nitrogen of the specific crop.
